(19) United States
(12) Patent Application Publication
(10) Pub. No.: US 2006/0090860 A1
(43) Pub. Date: May 4, 2006

(54) Device for stopping rotation of a shaft

(76) Inventor: Stephen Noel Corboy, Greenacres (AU)

Correspondence Address: F. CHAU & ASSOCIATES, LLC, 130 WOODBURY ROAD, WOODBURY, NY, 11797, US

(21) Appl. No.: 10/514,954

(22) PCT Filed: May 13, 2003
(86) PCT No.: PCT/AU03/00575

§ 371 Date: Aug. 4, 2005

(30) Foreign Application Priority Data
May 13, 2002 (AU) PS 2249

(51) Int. Cl. E06B 9/08

(52) U.S. Cl. 160/133

(57) ABSTRACT

A device is disclosed for stopping rotation of a shaft (4) for moving a flexible shutter (16) between a retracted (18) and an extended position (20). The device includes a stop means (22) and an abutment means (24) for abutting with the stop means. The abutment means is secured so as to have a first position (36) and a second position (38). The stop means and the abutment means are arranged so that when the shutter is in the extended position (20) the abutment means (24) and the stop means (22) form a rigid engagement having an end (26) attached to the shaft (4). The rigid engagement stops the shaft (4) from rotating and thus prevents the shutter from passing the extended position.

### FIELD OF INVENTION

The present invention relates to a device for stopping rotation of a shaft. In a typical application, the device may be used to stop rotation of a shaft which is attached to a flexible shutter for a door or window or other type of structure.

Shutter assemblies of this type are often referred to as “roller doors” or “roller shutters”. However, this invention is not limited to any one particular application as it will be equally suited to function in relation to the operation of roller doors or shutters or any other like application.

### BACKGROUND OF THE INVENTION

A shutter assembly has a shutter that normally comprises a plurality of segments or slats that are connected at each edge to one another by a hinge. This provides a flexible shutter that can be wound on or off the shaft so as to wind the shutter between a retracted position and an extended position respectively by rotating the shaft.

The shaft is normally positioned above a window or opening, and may be mounted within an enclosure, such as a head box. Guide rails are provided at either side of the shutter assembly, within which edges of the shutter locate so that the shutter is constrained in a planar form as it is wound from the shaft.

When the shaft is normally positioned above a window or opening, the retracted position corresponds to a “fully up” position and the extended position corresponds to a “fully down” position. Of course, the relative positioning of the shutter in either the extended or retracted position will vary according to the positioning of the shaft relative to the window or opening as well as the orientation of the window or opening. For example, when the shaft is mounted below a vertical window or opening the retracted position may correspond to a “fully down” position and the extended position may correspond to a “fully up” position.

The winding of the shutter can be achieved manually through a hand crank mechanism that rotates the shaft. However, it is also common to make use of electric motors (such as tubular motors) which drive the shaft.

In shutter assemblies which use an electric motor to drive the shaft it is important to sense when the shutter reaches the extended position so as to disconnect power from the electric motor (so as to stop the motor) and so prevent further rotation of the shaft.

The extended position is often sensed using limit switches which are activated when the shutter reaches the extended position. Such limit switches are normally contained within inside the drive unit or shaft.

It can be advantageous to replace the limit switches with current sensing. The use of current sensing is dependent on the provision of mechanical stops in the shutter assembly that are capable of applying a torque to the drive unit so as to exceed a normal operating torque of the drive unit when the shutter is being wound between the retracted and the extended position. When the torque exceeds the normal operating torque, the current demanded by the electric motor exceeds a normal operating current. The increase in current is able to be sensed using current sensing means, and used to stop the electric motor.

In the case of current sensing, it is easy to sense the retracted position as there are normally physical means that stop the roller shutter from extending above a certain level, such means typically apply sufficient torque to the electric motor to increase applied torque (and hence current) above the normal operating levels to permit the higher current to be sensed by the current sensing means.

However, it is more difficult to sense the extended position because typical shutter assemblies are not operable so as to increase the electric motor torque sufficiently higher than the normal operating torque so as to result in a detectable current increase at the moment the shutter is in the extended position.

As a result, even if the shutter reaches its extended position, the shaft may continue to rotate due to there being some flexibility of the shutter extending from the shaft. In such a case, a hinge point between the end of the shutter and the shaft can continue to rotate with the shutter even though the shutter has reached its extended position.

A further problem with existing approaches for sensing when the shutter reaches the extended position in they do not operatively interact with the flexible shutter directly. As a result, such approaches operate independently of the actual position of the shutter and typically require adjustment or alignment following installation Moreover, such arrangements are typically quite complicated to implement, resulting in higher manufacturing costs.

It is an object of the invention to provide an improved device for stopping rotation of the shaft once the shutter reaches the extended position.

It is a further object of the invention to provide a stopping device which operatively interacts with a flexible shutter so as to stop rotation of the shaft once the shutter reaches the extended position.

### SUMMARY OF THE INVENTION

In one form of the invention, the present invention provides a device for stopping rotation of a shaft when a shutter having a connection to the shaft reaches an extended position, the device including:
a. a stop means; and
b. an abutment means for abutting with the stop means;
   wherein the stop means and the abutment means are arranged so that when the shutter is in the extended position the stop means and the abutment means form a rigid engagement having an end attached to the shaft, said rigid engagement stopping rotation of the shaft.

The abutment means may be secured to the shaft so as to be movable between a first position and a second position. Securing the abutment means in this way preferably results in the rigid engagement being formable when the abutment means is in the second position and not being formable when the abutment means is in the first position.

The securing of the abutment means to the shaft may allow the abutment means to move pivotably with respect to the shaft. In such a case, the abutment means may be a pawl which is secured to the shaft so that the pawl is pivotably movable between the first and the second position.

Alternatively, the securing of the abutment means to the shaft may entail the abutment means being received within a receptacle located on the shaft so as to be retainable therein. In this case, the abutment means may be arranged radially relative to the shaft and slidably moveable between the first position and the second position. Here, the abutment means may be an elongate member having a retaining portion (such as a head) and a pin extending therefrom. The retaining member may be arranged so as to retain the abutment means to the receptacle and thus the shaft.

In an alternative embodiment of the present invention, the abutment means may not be secured to the shaft, but instead be secured so that the shaft is rotatable relative to the abutment means. In this form of the invention, the stop means may be located on the shaft so that the rigid engagement is formable when the shutter is in the extended position and not formable when shutter is in the retracted position.

Preferably, the securing of the abutment means allows the abutment means to interact with the flexible shutter so as to allow the abutment means to form the rigid engagement with the stop means when the shutter is in the extended position.

Where the abutment is secured to the shaft, it may be secured at a location so that when a section of the shutter is wound onto the shaft at least one segment of the shutter bears against the abutment means to thereby hold the abutment means in the first position. In an interaction of this type, once the shutter has been unwound from the shaft the segment no longer bears onto the abutment means and so the abutment means may move so as to engage the stop means and so stop further rotation of the shaft.

Alternatively, where the abutment means is secured so that the shaft rotates relatively to the abutment means, the interaction between the abutment means and the shutter may entail an end of the abutment means gradually moving between a first position and a second position as the shutter is wound from the retracted to the extended position respectively.

In the first position, the end of the abutment means rests upon a surface of segment(s) of the shutter which remains on the shaft so as to thereby separate the abutment means from the stop means. That is, the abutment means will rest on one or more of the segments which form an outside diameter.

In this way, when there are segments of the shutter wound around the shaft, the end of the abutment means will be held at a first distance relative to the axis of the shaft, said first distance being greater than the outside distance of the stop means relative to the shaft.

However, as the shutter is unwound from the shaft, the outside diameter correspondingly decreases so that the end of abutment means gradually moves radially inward. Once the shutter has been unwound from the shaft the end of the abutment means is located at a distance which allows the abutment means to engage with the stop means and so stop further rotation of the shaft.

The abutment means may be biased so that when the shutter is unwound from the shaft the abutment means moves to the second position.

The abutment means may be biased using any suitable biasing means. One suitable biasing means may include a resilient means, such as a spring. Other suitable biasing means may include gravitationally biasing, magnetic biasing, and hydraulic biasing.

In embodiments of the invention where the abutment is secured to the shaft, the stop means may be located so that the shaft rotates relative to the stop means. In such a case, it is preferred that the stop means be arranged so as to intersect a path of rotation of the abutment means when the abutment means is in the second position (and thus when the shutter is in, or is approaching, the extended position).

One suitable abutment means and stop means arrangement may be provided by arranging the stop means on a surface which is located proximal to a side edge of the shutter. Indeed, in one form of the invention, the stop means may be arranged on the surface of a drive unit which is coupled to an end of the shaft.

In some embodiments of the invention the stop means may be not be located on the drive unit, but still be arranged relative to the abutment means so as to allow the stop means to intercept the abutment means appropriately. For example, the stop means may be arranged on a support structure which is located at an end of the shaft. One suitable support structure may be a wall which is arranged at an opposite end of the shaft relative to the drive unit. Another suitable support structure may be a plate having an axle, or bearing, about which the shaft rotates. Yet another suitable support structure may be a head box for the shutter assembly.

The stop means may be any suitable form of stop means. It may be a boss which is formed on, or fixed to, the drive unit, or other support structure. One suitable boss may be a stud which is fixed by suitable means. Another suitable boss may be formed during manufacture of the drive unit or support structure (for example, during casting or machining). It will be appreciated that a variety of other implementations of the stop means are possible.

In another form of the invention, the abutment means may be a link which is pivotably mounted between a perimeter of the shaft and a first edge of the flexible shutter. The link may have a first end located towards the shaft. In this form of the invention, the stop means may be a particular region of the surface of the shaft proximal to the first end, so that when the shutter is in the extended position the first end bears against the region so as to cause a second end of the link to exert a force on the first edge of the flexible shutter. The exertion of a force on the first edge of the flexible shutter may cause a second edge of the shutter to bear against a ledge member so as to form the rigid engagement.

The present invention also provides an attachment for attaching to a shaft, the shaft being attached to an end of a flexible shutter which is windable around the shaft, the attachment including:
a. a body for attaching to the shaft; and
b. an abutment means secured to the body, the abutment means being movable between a first position and a second position;
   wherein the abutment means is held in the first position when a segment of the flexible shutter bears against abutment means and is moveable to the second position when no segment of the flexible shutter bears against the abutment means.

The attachment means may include biasing means for moving the abutment means to the second position when no segment of the flexible shutter bears against the abutment means. Alternatively, the attachment may be arranged so the abutment is moveable to the second position using gravitational biasing when no segment of the flexible shutter bears against the abutment means.

The body may be a collar which is attachable around the perimeter of the shaft. Alternatively, it may be a mounting block which is attachable to a surface region of the shaft. Another suitable body may be a body which is attachable to an end of the shaft.

Where the attachment means is a body which is attachable to an end of the shaft, the attachment means may be capable of connecting the shaft to a suitable shaft support means. In the way, the attachment means may be used to attach the shaft to the shaft support means so that the attachment means is located between the shaft support means and the end of the shaft.

One shaft suitable support means may be a stub axle. In this form, the attachment means may include a bearing means for attaching the shaft to the stub axle.

Another suitable shaft support means may be the drive unit itself. Thus, the present invention also provides a drive train assembly for rotating a shaft, the shaft being connected to an end of a flexible shutter so that the shutter is windable around the shaft, the drive train including:
a. a drive unit for providing a rotational force to the shaft so as to wind the flexible shutter between a retracted and an extended position;
b. a stop means having a fixed position relative to the drive unit;
c. an attachment for coupling the drive unit to the shaft, the attachment including:
   i. a body having a first end which is connectable to the drive unit and a second end which is connectable to an end of the shaft; and
   ii. an abutment means which is secured to the body so as to be held in a first position when a segment of the flexible shutter bears against abutment means and is moveable to a second position when no segment of the flexible shutter bears against the abutment;
      wherein the stop means and the abutment means are arranged so that when the flexible shutter is in the extended position, the stop means and the abutment means form a rigid engagement which stops rotation of the adapter.

The present invention also provides a roller shutter assembly, including:
a. a flexible shutter;
b. a shaft for connecting to the flexible shutter so that the flexible shutter is windable around the shaft;
c. one or more drive units for providing a rotational force to the shaft so as wind the flexible shutter between a retracted and an extended position;
d. a device for sensing when the flexible shutter is in the extended position, the device including:
   i. a stop means; and
   ii. an abutment means for abutting with the stop means;
      wherein the stop means and the abutment means are arranged so that when the shutter is in the extended position the stop means and the abutment means form a rigid engagement having an end attached to the shaft, said rigid engagement stopping rotation of the shaft.

Each drive unit may include an electric motor and gearbox assembly for generating the rotational force. One suitable drive unit may be a tube motor designed to mount within the shaft.

In this form, the roller shutter assembly may include a control device for sensing an increase in load current of the electric motor(s), said increase being caused by the forming of the rigid engagement. It is preferred that the control device be responsive to detecting an increase in the load current to thereby disconnect power from the electric motor.

Alternatively, the drive unit may be a manually operable unit. One suitable manually operable unit may be a hand crank mechanism that rotates the shaft.

The present invention also provides a device for stopping rotation of a shaft, the shaft being rotatable to move a flexible shutter between a retracted position and an extended position, the device including:
a. a stop means; and
b. an abutment means for abutting with the stop means;
   wherein the abutment means interacts with the shutter so that the abutment means forms a rigid engagement with the stop means when the shutter is in the extended position, said rigid engagement stopping the flexible shutter from passing the extended position.

The interaction of the abutment means with the shutter preferably includes the shutter bearing against the abutment means so as to hold the abutment means in a first position when the shutter is in the retracted position, and allows the abutment means to move to a second position when the shutter does not bear against the abutment means. Of course, it will be appreciated that as the shutter travels between the retracted position and a position which is proximal to the extended position, the shutter will also bear against the abutment means as so hold the abutment means in the first position.

The present invention also provides a roller shutter assembly including:
a. a flexible shutter;
b. a shaft for connecting to the flexible shutter so that the flexible shutter is windable around the shaft;
c. a drive unit for providing a rotational force to the shaft so as wind the flexible shutter between a retracted and an extended position;
d. a device for sensing when the flexible shutter is in the extended position, the device including:
   i. a stop means; and
   ii. an abutment means for abutting with the stop means;
      wherein the abutment means interacts with the shutter so that the abutment means forms a rigid engagement with the stop means when the shutter is in the extended position, said rigid engagement stopping the flexible shutter from passing the extended position.

### DESCRIPTION OF THE DRAWINGS

The present invention will now be described in relation to various embodiments illustrated in the accompanying drawings. However, it must be appreciated that the following description is not to limit the generality of the above description.

In the drawings:

FIG. 1a is a front isometric view of a shutter assembly with a flexible shutter in an extended position, the shutter assembly having a device according to a first preferred embodiment of the invention;

FIG. 1b is a bottom cross sectional view showing the relationship between the abutment means and the stop means in the assembly of FIG. 1 when the shutter of FIG. 1 is in an extended position.

FIG. 2a is a front isometric view of the shutter assembly of FIG. 1 with the flexible shutter in a retracted position;

FIG. 2b is a bottom cross sectional view showing the relationship between the abutment means and the stop means in the assembly of FIG. 2 when the shutter of FIG. 2 is in an retracted position.

FIG. 3 is an exploded view of the device according to the first preferred embodiment of the invention;

FIG. 4 is an end cross sectional view of the positional relationship between the abutment means and a stop means of the preferred embodiment of FIG. 1 when the shutter is in a retracted position;

FIG. 5 is an end cross sectional view of the positional relationship between the abutment means and the stop means of FIG. 4 when the shutter is approaching the extended position;

FIG. 6 shows an end cross sectional view of the positional relationship between the abutment means and the stop means of FIG. 4 when the shutter is in the extended position;

FIG. 7 shows a device according to a second preferred embodiment of the invention;

FIG. 8a shows a device according to a third preferred embodiment of the invention having a shutter located between an extended and a retracted position.

FIG. 8b shows a device according to a third preferred embodiment of the invention having a shutter located at an extended retracted position.

### DETAILED DESCRIPTION OF A PREFERRED EMBODIMENT OF THE INVENTION

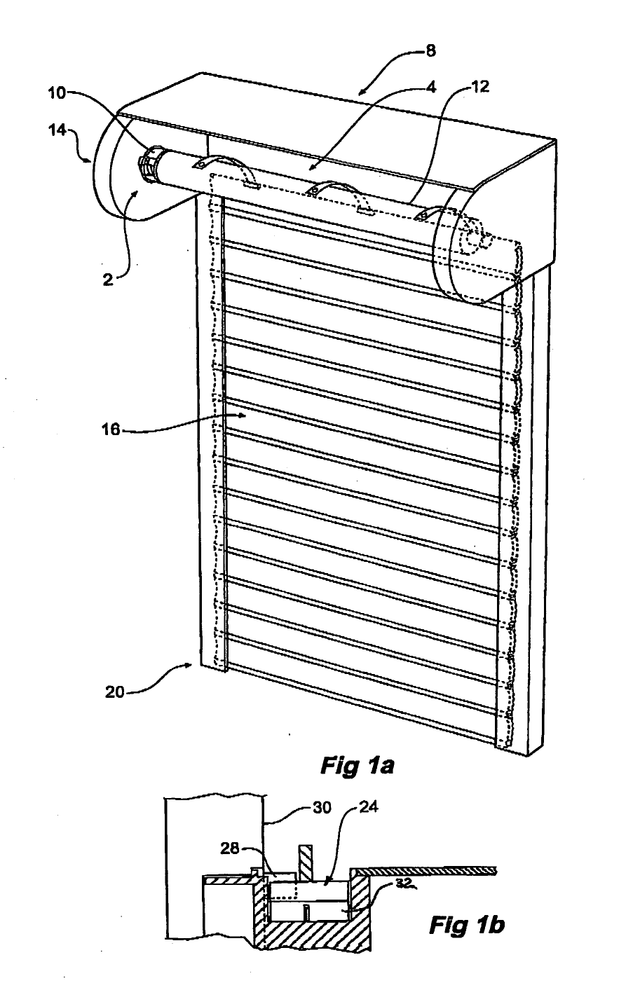

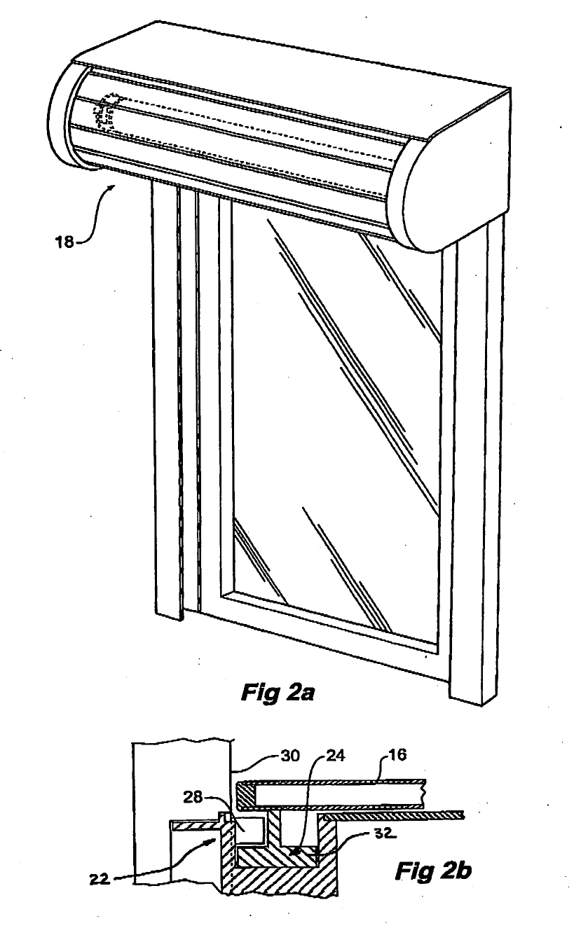

Referring initially to FIGS. 1 and 2 of the drawings, there is shown a first preferred embodiment of a device 2 for stopping rotation of a shaft 4 of a shutter assembly 8. The shaft 4, in this case includes an axle adapter 10 and a drum 12. In this respect, although the shaft 4 described herein is a two part assembly consisting of the axle adapter 10 and a drum 12, it will be appreciated that the shaft could be a single member.

The shutter assembly 8 shown here includes a drive unit 14 which is connected to the shaft 4 so as to allow the shaft 4 to be rotated by the drive unit 14, and thus move a flexible shutter 16 between a retracted position 18 (ref. FIG. 2) and an extended position 20 (ref. FIG. 1). The device 2 stops rotation of the shaft 4 when the flexible shutter 16 reaches the extended position 20 and thus prevents the shutter 16 from passing the extended position 20.

In the embodiment illustrated, the drive unit 14 includes an electric motor (not shown) coupled to a gearbox assembly (not shown) so as to provide a rotational force to the shaft 4 to thereby move the shutter 16. Ideally, the drive unit 14 is reversible so that the shutter 16 may be moved between the retracted position 18 and the extended position 20 in both directions.

Although the preferred embodiment of the invention will be described as including a drive unit 14 which includes an electric motor, it will be appreciated that the drive unit 14 could equally be manually driven, such as by way of a hand crank mechanism that is able to rotate the shaft 4. Moreover, although the drive unit 14 will be described as being arranged towards an end of a shaft 4, it is to be understood that other arrangements are possible. Indeed, in an alternative embodiment of the invention, the drive unit may be a tube motor which is located within the shaft 4 itself.

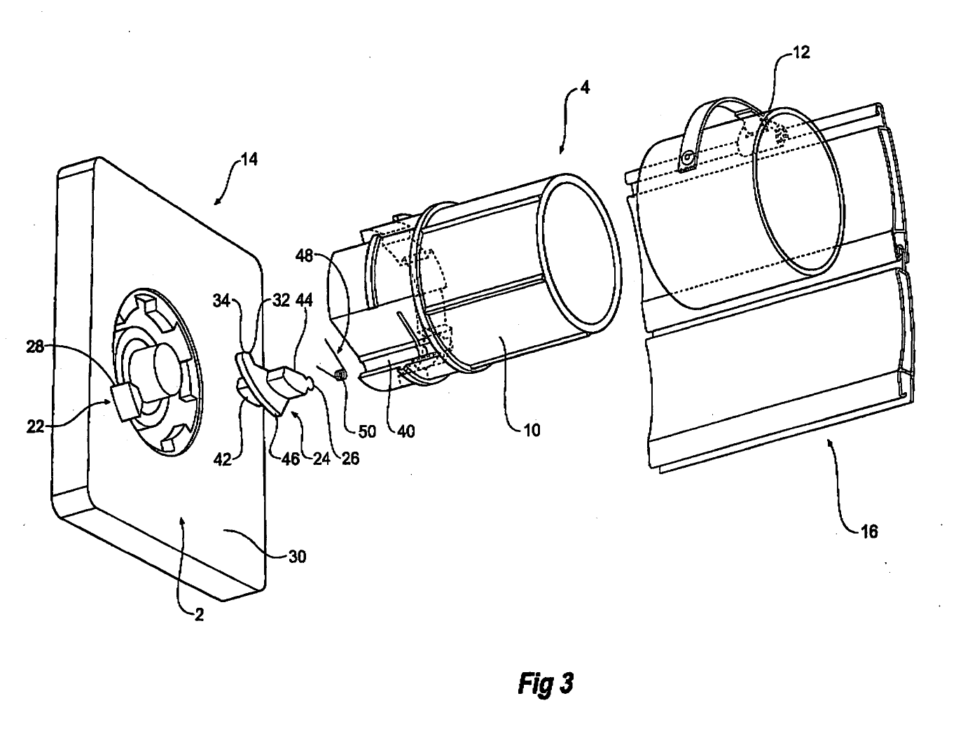

As is shown in FIGS. 1 to 3, the device 2 includes a stop means 22 and an abutment means 24 for abutting with the stop means 22 when the flexible shutter 16 is in the extended position 20 (ref FIG. 1) so as to form a rigid engagement. More particularly, the stop means 22 and the abutment means 24 are arranged so that when the flexible shutter 16 is in the extended position 20 (ref FIG. 1) the stop means 22 and the abutment means 24 form a rigid engagement having an end 26 (ref. FIG. 3) attached to the shaft 4. The rigid engagement stops the shaft 4 from rotating so as to further unwind the shutter 16 from the shaft 4 and thus prevents the shutter 16 from passing the extended position 20.

Since the device 2 may be used with flexible shutters 16 having different distances between the retracted 18 and the extended position 20, or having different head box geometries (for example, different head boxes may have difference distances between the guides and the shaft) the angular position of the stop means 22 relative to the abutment means 24 may be adjusted so as to allow the rigid engagement to be formed correctly upon the shutter 16 reaching the extended position 20. In some embodiments, such adjustment may be achieved by adjusting the angular position of the stop means 22 relative to the shaft 4.

In FIGS. 1 to 6, the stop means 22 is shown as a boss 28 which protrudes from a surface 30 of the drive unit 14. As is shown in FIG. 2b, the boss 28 protrudes a sufficient distance from the surface 30 so to overlap a path of rotation in which the abutment means 24 moves during rotation of the shaft 4 so that the boss 28 is able to intercept the abutment means 24 when the shutter 16 is in the extended position 20 (ref FIG. 1).

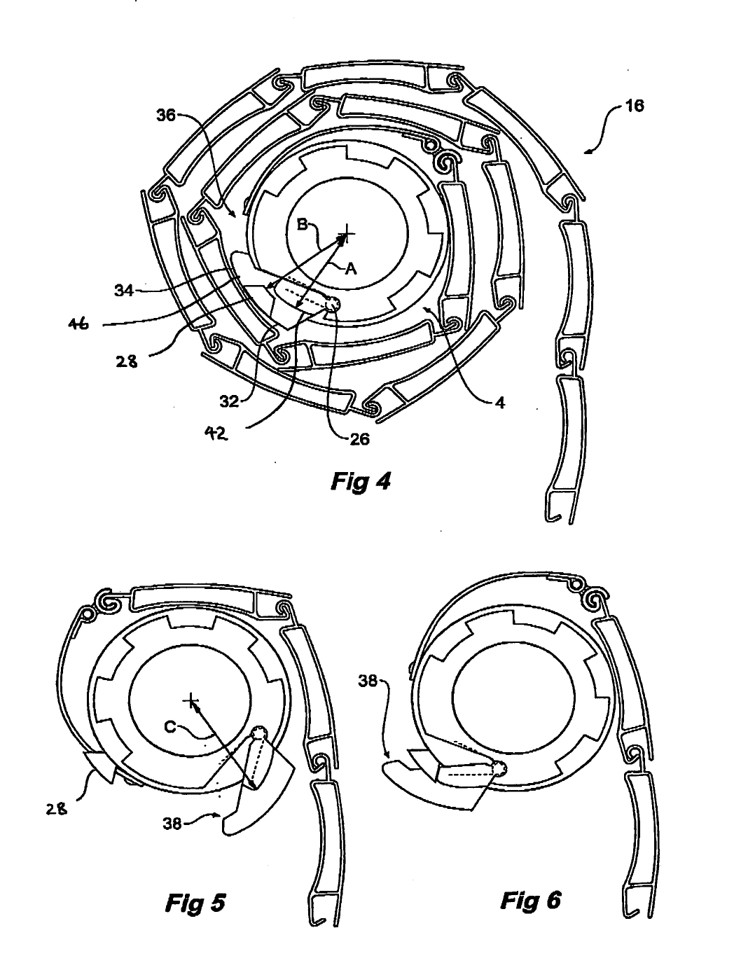

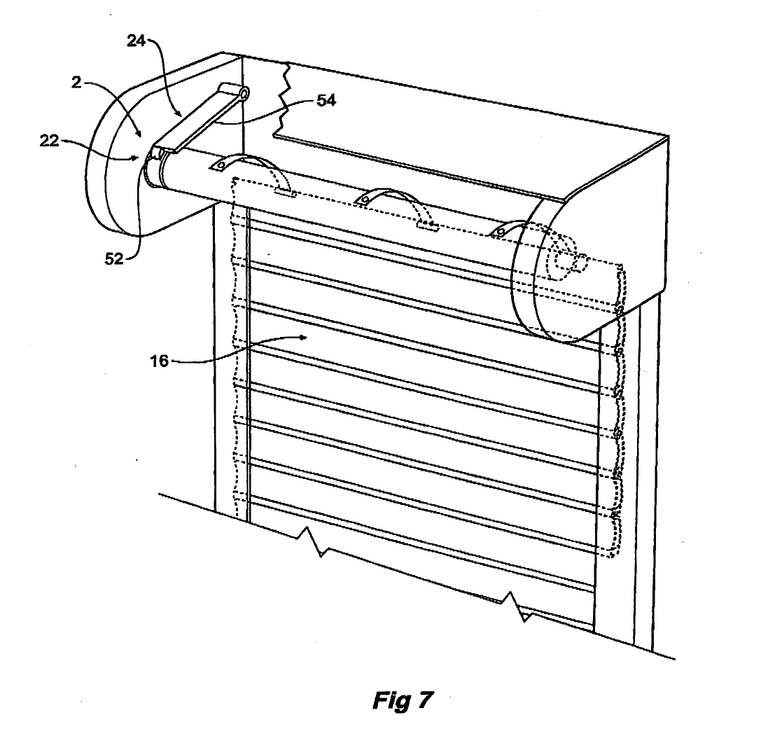

As is shown in FIGS. 1 to 6, in the preferred embodiment, the abutment means 24 is a pawl 32 which is secured to the shaft 4 so that a free end 34 of the pawl 32 is movable between a first position 36 (ref FIG. 4) and a second position 38 (ref FIG. 6) relative to the shaft 4. As is shown in FIG. 3, the other end 26 of the pawl 32 is shaped so as to be received within a correspondingly shaped receptacle 40 located on an end of the shaft 4 so as to thereby provide the pivotable movement.

In this respect, although the abutment means 24 will be described as having an end 26 which is secured to the shaft 4, it will be appreciated that the securement need not be a ‘direct’ one. Indeed, in an alternative embodiment of the invention, the abutment means 24 may be fitted to an attachment (such as a collar, a bracket, a sleeve, an adapter, or the like) which is in turn fitted around, or on, the shaft 4 so as to indirectly secure the abutment means 24 to the shaft 4. Accordingly, for the purposes of the description, reference to the term ‘secured’, when used in the context of the relationship between the abutment means 24 and the shaft 4, is to be understood to be reference to both ‘direct’ and ‘indirect’ types of securing.

As is shown in FIGS. 4 to 6, in the present case the pawl 32 is pivotably connected to the shaft 4 so that the free end 34 of the pawl 32 is pivotably movable between the first position 36 and the second position 38 so that the rigid engagement between the boss 28 and the pawl 32 is formable when the pawl 32 is in the second position 38 and not formable when the rigid engagement is in the first position 36.

The pawl 32 shown in FIGS. 1 to 6 includes flanges 42, 44 (ref FIG. 3) having a ridge 46 therebetween which projects perpendicularly to the longitudinal axis of the shaft 4. It is not essential that the pawl 32 include flanges 42, 44, since the pawl 32 may have any geometry which is suitable for interacting with the shutter 16 so as to form a rigid engagement with the stop means 22 when the shutter 16 is in the extended position 20. Nonetheless, it is preferred that the flanges 42, 44 be provided. The purpose of the flanges 42, 44 and the ridge 46 will be described in more detail later.

As is shown in FIG. 3, the pawl 32 is biased using a biasing means 48 so that when the shutter 16 is in, or is approaching, the extended position 20, the pawl 32 is moved to the second position 38 by the biasing means 48.

In FIG. 3, the biasing means 48 is shown as a spring 50 which is located between the axle adapter 10 of shaft 4 and the pawl 32 so as to exert a force onto the pawl 32. The force biases the pawl 32 so as to normally locate the pawl 32 in the second position 38. In the embodiment illustrated, the spring 50 has two legs which extend from a helical portion. Each leg is received within a correspondingly shaped receptacle in the axle adapter 10 and the pawl 32 respectively. Thus, when the spring 50 is inserted between the pawl 32 and the axle adapter 10, the legs of spring 50 positively engage with their respective receptacles and thereby locks the pawl 32 to the axle adapter 10 so as to prevent the pawl 32 from moving axially.

Turning now to FIGS. 4 to 6 there is shown a typical interaction between the pawl 32 and the shutter 16 during unwinding of the shutter 16.

As is shown in FIG. 4, when the shutter 16 is not in, or is not approaching, the extended position 20, one or more segments of the shutter 16 are wound around the shaft 4 so that an edge of at least one of the segments of the shutter 10 remaining on the shaft 4 overlies a portion of the pawl 32. In this configuration at least one of the segments bears against the pawl 32 so as to hold it in the first position 36. Indeed, in the embodiment illustrated, the edge of one or more of the shutter segments lies over the ridge 46 of pawl 32 to thereby bear against the ridge 46 and hold the pawl 32 in the second position 38.

In the illustrated embodiment, whilst a segment of the shutter 10 bears against the pawl 32 (by way of bearing on the ridge 46), the flange 42 is able to pass between the boss 28 and the periphery of shaft 4 and is thus not able to form the rigid engagement. More specifically, when the shutter 10 bears against the pawl 32 so as to locate the pawl in the first position, the outside distance “A” between a top surface of flange 42 and the axis of the shaft 4 is less that the distance “B” between the inside of the boss 28 and the shaft 4. Thus, in this condition the shaft 4 is not stopped from rotating.

Turning now to FIG. 5, as the shutter is unwound from the shaft, there will come a stage during the unwinding of the shutter when the segment which beared against the pawl 32 will be unwound from the shaft and thus no longer bear against the pawl 32. At this stage, the pawl 32 moves to the second position 38 under the influence of the biasing means 48. At the second position 38 the pawl 32 is located so that the outside distance “C” is greater than distance “B” (ref FIG. 4).

As is shown, the pawl 32 moves to the second position 38 before the shutter 16 actually reaches the extended position 32 so as to allow the pawl 32 to engage with the boss 28 upon the shutter 16 reaching the extended position 20. Thus, the formation of the rigid engagement between the pawl 32 and the boss 28 will not occur until the shutter 16 is in the extended position 20. Thus, at the stage shown in FIG. 5, the shaft 4 will continue to rotate, and thus unwind the shutter 16, until the pawl 32 forms the rigid engagement with the boss 28 some time after the 32 pawl has moved to the second position 38.

As is shown in FIG. 6, rotation of the shaft will stop when the boss 28 intercepts the pawl 32 so as to form the rigid engagement. In the illustrated embodiment, the free end 34 of the pawl 32 is positioned so that the flange 42 intercepts the boss 28 at the moment the shutter 16 reaches the extended position 20 and so form the rigid engagement with the boss 28. The rigid engagement prevents the shutter 16 from passing the extended position 20.

FIG. 7 shows a device 2 according to a second preferred embodiment of the invention. The device of FIG. 7 is similar to that described in relation to the first preferred embodiment of the invention except that the location of the stop means 22 and the abutment means 24 have been interchanged.

As was the case for the first preferred embodiment of the invention, the rigid engagement between the stop means 22 and the abutment means 24 is formed when the shutter 16 is in the extended position 20. In the present case, when the shutter 16 is not in, or is not approaching, the extended position 20 the abutment means 24 interacts with the shutter 16 so as to prevent the abutment means 24 from engaging with the stop means 22.

Thus, in this case, the interaction between the abutment means and the shutter may entail an end of the abutment means gradually moving between a first position and a second position as the shutter is wound from the retracted to the extended position respectively.

In the illustrated embodiment, the width of the abutment means 24 is greater than that of the stop means 22 so that the abutment means normally rests on the shutter segments which are wound onto the shaft 4 and so prevents the abutment means 24 from engaging with the stop means 22. Thus, when the shutter is in the retracted position, the end of the abutment means rests upon a surface of segment(s) of the shutter which remains on the shaft so as to thereby separate the abutment means from the stop means and so hold the abutment means in the first position. That is, the abutment means will rest on one or more of the segments which form an outside diameter.

In this way, when there are segments of the shutter 16 wound around the shaft 4, the end of the abutment means 24 will be held at a first distance relative to the axis of the shaft 4, said first distance being greater than the outside distance of the stop means 22 relative to the shaft 4.

However, as the shutter 16 is unwound from the shaft 4, the outside diameter correspondingly decreases so that the end of abutment means 24 (shown here as a pawl 54) gradually moves radially inward. Once the shutter 16 has been unwound from the shaft 4, the end of the abutment means 24 is located at a distance from the axis of the shaft which allows the abutment means 24 to engage with the stop means 22 and so stop further rotation of the shaft 4.

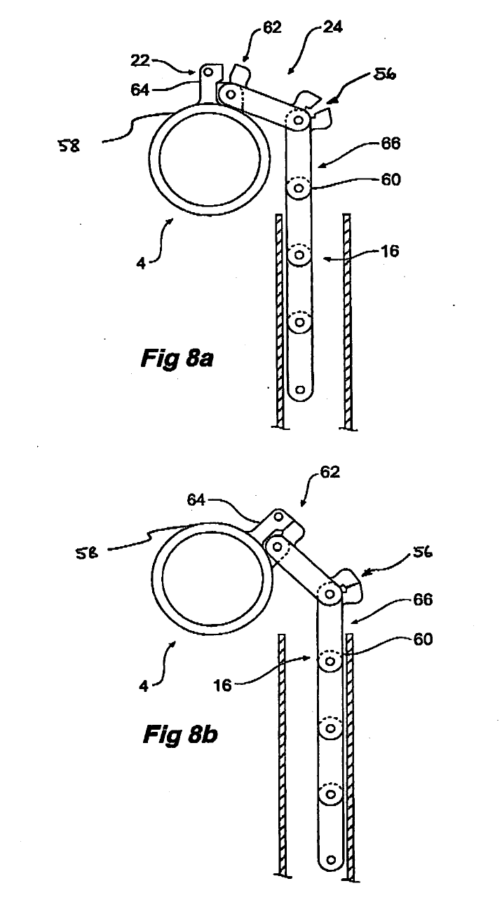

Turning to FIGS. 8a and 8b, there is shown a third preferred embodiment of the invention. Here, the abutment means 24 is shown as a link 56 which is pivotably mounted between a perimeter 58 of the shaft 4 and a first edge 60 of the flexible shutter 16.

The link 56 includes a first end 62 which is located towards the shaft 4. The stop means 22 shown here is a region 64 of the shaft 4 which's proximal to the first end 62.

As is shown in FIG. 8b, when the shutter 16 is in the extended position the first end 62 of the link 56 bears against the region 64 so as to cause a second end 66 of the link 56 to exert a force on the first edge 60 of the flexible shutter 16.

The force which is exerted onto the first edge 60 of the flexible shutter 16 causes a second edge (not shown) of the shutter 16 to bear against a ledge member (not shown) so as cause the abutment means 24 and the stop means 22 to form the rigid engagement.

Advantageously, where a device according to the present invention is used with a shutter assembly having drive unit which includes an electric motor, the device may be used in conjunction with a control device, including a current sensing device and suitable switches, so as to sense the higher current of a stalled condition of the motor and disconnect power from the motor when the shutter is in the extended position so as to thereby stop the motor. In such an implementation, the stopping of the rotation of the shaft of the shutter using the device effectively stalls the electrical motor, and consequently results in the motor demanding more current. The increase in current is sensed by current sensing devices which respond by disconnecting power from the electric motor.

Finally, it will be understood that there may be other variations and modifications to the configurations described herein that are also within the scope of the present invention.

1. A device for stopping rotation of a shaft when a shutter having a connection to the shaft reaches an extended position, the device including:
a. a stop means; and
b. an abutment means for abutting with the stop means;
wherein the stop means and the abutment means are arranged so that when the shutter is in the extended position the stop means and the abutment means form a rigid engagement having an end attached to the shaft, said rigid engagement stopping rotation of the shaft.

2. A device according to claim 1 wherein the abutment means is secured to the shaft so as to be movable between a first position and a second position such that the rigid engagement is formable when the abutment means is in the second position and not formable when the abutment means is in the first position.

3. A device according to claim 2 wherein the securing of the abutment means allows the abutment means to move pivotably relative to the shaft.

4. A device according to claim 3 wherein the abutment means is a pawl which is secured to the shaft so that the pawl is pivotably movable between the first and second position.

5. A device according to claim 1 wherein the securing of the abutment means to the shaft includes receiving the abutment means with a receptacle located on the shaft, the receptacle being arranged radially relative to the shaft such that the abutment means is moveable between a first position and a second position.

6. A device according to claim 1 wherein the abutment means is secured so that the shaft is rotatable relative to the abutment means.

7. A device according to claim 2, wherein the securing of the abutment means allows the abutment means to interact with the flexible shutter.

8. A device according to claim 7, wherein the interaction includes:
a. a section of the shutter bearing against the abutment means to thereby hold the abutment means in the first position when at least some of the shutter is wound around the shaft; and
b. the shutter not being on the abutment means when no section of the shutter is wound around the shaft so that the abutment means can move so as to engage the stop means to stop further rotation of the shaft.

9. A device according to claim 7, wherein the interaction includes:
a. the abutment means resting upon a segment(s) of the shutter which remain on the shaft so as to separate the abutment means from the stop means such that as said segments are unwound from the shaft an end of the abutment means gradually moves radial inwardly towards the stop means; and
b. the abutment means moving to a second position which allows the abutment means to engage with the stop means when the shutter is unwound from the shaft.

10. A device according to claim 2, wherein the abutment means is biased so that when the shutter is unwound from the shaft the abutment means moves to the second position.

11. A device according to claim 10 wherein the abutment means is biased using a biasing means.

12. A device according to claim 11 wherein the biasing means is a resilient member.

13. A device according to claim 12 wherein the resilient member is a spring.

14. A device according to claim 10 wherein the abutment means is gravitationally biased.

15. A device according to claim 2, wherein the stop means is located so that the shaft rotates relative to the stop means.

16. A device according to claim 15 wherein stop means is arranged so as to intersect a path of rotation of the abutment means when the abutment means is in the second position.

17. A device according to claim 6 wherein the stop means is located on the shaft.

18. A device according to claim 1 wherein the abutment means is a link which is pivotably mounted between a perimeter of the shaft and a first edge of the flexible shutter, the link having a first end located towards the shaft, and wherein the stop means is a region of the surface of the shaft, which region is proximal to the first end of the link, so that when the shutter is in the extended position the first end of the link bears against the region so as to cause a second end of the link to exert a force on the first edge of the flexible shutter and thereby form the rigid engagement.

19. An attachment for attaching to a shaft, the shaft being attached to an end of a flexible shutter which is windable around the shaft, the attachment including:
a. a body for attaching to the shaft; and
b. an abutment means secured to the body, the abutment means being movable between a first position and a second position;
wherein the abutment means is held in the first position when a segment of the flexible shutter bears against abutment means and is moveable to the second position when no segment of the flexible shutter bears against the abutment means.

20. An attachment according to claim 19 including biasing means to move the abutment means to the second position when no segment of the flexible shutter bears against the abutment means.

21. An attachment according to claim 19, wherein the body is a collar which is attachable around the perimeter of the shaft and fixedly connectable thereto.

22. An attachment according to claim 19, wherein the body is a mounting block which is able to be attached to a surface region of the shaft.

23. An attachment according to claim 19, wherein the body is attachable to an end of the shaft.

24. An attachment according to claim 19, wherein the body is attachable to a shaft supporting means so that the attachment connects the shaft and the supporting means.

25. An attachment according to claim 24 wherein the shaft supporting means is a drive unit.

26. An attachment according to claim 24 wherein the shaft supporting means is a stub axle.

27. A drive train assembly for winding a shaft, the shaft being connected to an end of a flexible shutter so that the shutter is windable around the shaft, the drive train including:
a. a drive unit for providing a rotational force to the shaft so as to wind the flexible shutter between a retracted and an extended position;
b. a stop means having a fixed position relative to the drive unit;
c. an attachment for coupling the drive unit to the shaft, the attachment including:
i. a body having a first end which is connectable to the drive unit and a second end which is connectable to an end of the shaft; and
ii. an abutment means which is secured to the body so as to be held in a first position when a segment of the flexible shutter bears against abutment means and is moveable to a second position when no segment, of the flexible shutter bears against the abutment means;
wherein the stop means and the abutment means are arranged so that when the flexible shutter is in the extended position, the stop means and the abutment means form a rigid engagement which stops rotation of the shaft.

28. A roller shutter assembly including:
a. a flexible shutter;
b. a shaft for connecting to the flexible shutter so that the flexible shutter is windable around the shaft;
c. one or more drive units for providing a rotational force to the shaft so as wind the flexible shutter between a retracted and an extended position;
d. a device for sensing when the flexible shutter is in the extended position, the device including;
i. a stop means; and
ii. an abutment means for abutting with the stop means;
wherein the stop means and the abutment means are arranged so that the shutter is in the extended position the stop means and the abutment means form a rigid engagement having an end attached to the shaft, said rigid engagement stopping rotation of the shaft.

29. A roller shutter according to claim 28 wherein each drive unit includes an electric motor.

30. A roller shutter assembly according the claim 29 including a control device for sensing an increase in load current of the electric motor(s), said increase being caused by the forming of the rigid engagement, the control device being responsive to detecting an increase in the load current to thereby disconnect power from the electric motor(s).

31. A device for stopping rotation of a shaft, the shaft being rotatable to move a flexible shutter between a retracted position and an extended position, the device including:
a. a stop means; and
b. an abutment means for abutting with the stop means;
wherein the abutment means interacts with the shutter so that the abutment means forms a rigid engagement with the stop means when the shutter is in the extended position, said rigid engagement stopping the flexible shutter from passing the extended position.

32. A device according to claim 31 wherein the interaction of the abutment means with the shutter includes the shutter bearing against the abutment means so as to hold the abutment means in a first position when the shutter is in the retracted position, and allowing the abutment means to move to a second position when the shutter does not bear against the abutment means so that the rigid engagement is formable when the abutment means is in the second position.

33. A roller shutter assembly including:
a. a flexible shutter;
b. a shaft for connecting to the flexible shutter so that the flexible shutter is windable around the shaft;
c. one or more drive units for providing a rotational force to the shaft so as wind the flexible shutter between a retracted and an extended position;
d. a device for sensing when the flexible shutter is in the extended position, the device including:
i. a stop means; and
ii. an abutment means for abutting with the stop means;
wherein the abutment means interacts with the shutter so that the abutment means forms a rigid engagement with the stop means when the shutter is in the extended position, said rigid engagement stopping the flexible shutter from passing the extended position.
